(19) United States
(12) Patent Application Publication
(10) Pub. No.: US 2026/0303582 A1
(43) Pub. Date: Oct. 1, 2026

(54) Dynamic Configuration Policy Based on Interface-Based Authentication

(71) Applicant: Arista Networks, Inc., Santa Clara, CA (US)

(72) Inventors: Hua Zhong, Los Altos, CA (US); Manish Singhvi, Bengaluru (IN); Leandro Lisboa Penz, Dublin (IE); Kaustav Majumdar, Bengaluru (IN); Michelle Binlu Wang, Sunnyvale, CA (US); Ronak Upadhyay, Bengaluru (IN)

(21) Appl. No.: 19/096,420

(22) Filed: Mar. 31, 2025

(51) Int. Cl. H04L 9/40

(52) U.S. Cl. CPC H04L 63/08

(57) ABSTRACT

A network device may have a network interface coupled to a supplicant device. The network device may obtain dynamic configurations for the network interface based on the supplicant device authenticated or authenticating for network access on the network interface and may apply the dynamic configurations to the network interface.

### BACKGROUND

A communication system can include multiple network devices that are interconnected to form a network for conveying network traffic between hosts. In some scenarios, a network device can include interfaces that are statically configured. However, using only static configurations, even when different types of devices connect to a given interface of the network device, the same static interface configurations will be used at the interface.

### BRIEF DESCRIPTION OF THE DRAWINGS

FIG. 1 is a diagram of an illustrative networking system having a network device, authentication equipment, and a supplicant device in accordance with some embodiments.

FIG. 2 is a diagram of an illustrative network device in accordance with some embodiments.

FIG. 3 is a diagram of an illustrative authenticator device configured to perform an authentication operation for a supplicant device using authentication equipment in accordance with some embodiments.

FIG. 4 is a diagram of an illustrative message identifying an interface profile in accordance with some embodiments.

FIG. 5 is a diagram of illustrative network device memory circuitry configured to store interface profile configurations in accordance with some embodiments.

FIG. 6 is a diagram of illustrative network device processing circuitry configured to process interface profile information in accordance with some embodiments.

FIG. 7 is a diagram of illustrative network device processing circuitry configured to execute a network device feature process based on configuration(s) from a dynamic configuration location in accordance with some embodiments.

FIG. 8 is a diagram of illustrative network device processing circuitry configured to execute a network device feature process based on configuration(s) from a static configuration location in accordance with some embodiments.

FIG. 9 is a flowchart of illustrative operations for dynamically applying network device interface configurations for an authenticated supplicant device in accordance with some embodiments.

### DETAILED DESCRIPTION

A network can include network devices for conveying network traffic, e.g., in the form of frames, packets, etc., between hosts or generally between devices in the network. To facilitate the appropriate network connectivity and/or other network configurations, network interfaces of network devices should each operate with the appropriate interface configurations when communicatively coupled to external devices (e.g., other network devices).

At least in some scenarios, these network device interfaces may be statically configured (e.g., static configurations are applied thereto). Accordingly, even when different types of devices are connected to such an interface, the same static interface configurations are applied to the interface. This approach to interface configuration may be inflexible and limiting. While network device interfaces can be manually configured (e.g., repeatedly configured with different static configurations) based on the device connected or intended to connect to each interface, this process can be tedious and error-prone. Furthermore, this approach may be impractical given the difficulty in managing these different interface configurations over time and at scale (e.g., for a large number of network devices, for a wide variety of interface configurations, etc.), especially for dynamic network deployments.

Accordingly, in illustrative examples described herein, network devices may dynamically configure network device interfaces (e.g., with different sets of dynamic configurations) depending on the device communicatively coupled to the corresponding interface. As an example, a network device may obtain the appropriate interface configurations (e.g., dynamic configurations) for a network interface based on a message received from an authentication server for a supplicant device communicatively coupled to the interface and apply the obtained configurations to the interface. These different interface configurations may be used to facilitate appropriate implementation of different network device features (e.g., a bridging feature, a port security feature, etc.). This approach provides flexibility to the interface configuration process (e.g., by setting up interfaces appropriately on an as-needed basis) and enables ease of management for various sets of interface configurations (e.g., by maintaining the sets of interface configurations in a centralized manner and distributing the appropriate interface configurations in connection with device authentication), among other advantages.

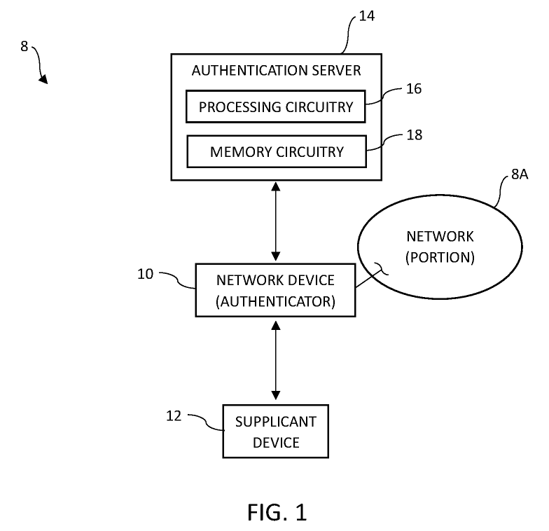

An illustrative networking system in which network device(s) are configured to dynamically configure network device interfaces (e.g., in the manner described above) is shown in FIG. 1. In the example of FIG. 1, the networking system may include one or more components of a network such as network 8. Network 8 may have any suitable scope. As examples, network 8 may include, be, and/or form part of one or more local segments, one or more local subnets, one or more local area networks (LANs), one or more virtual local area networks (VLANs), one or more campus area networks, one or more metropolitan area networks, one or more wide area networks, one or more datacenter networks, one or more cloud networks, etc. Network 8 may include a wired network (portion) based on wired technologies or standards such as Ethernet (e.g., using copper cables and/or fiber optic cables) and a wireless network (portion) such as one or more wireless local area networks (WLANs) (e.g., wireless networks compliant with the Institute of Electrical and Electronics Engineers (IEEE) 802.11 family of standard(s)). If desired, network 8 may include internet service provider networks (e.g., the Internet) or other public service provider networks, private service provider networks (e.g., multiprotocol label switching (MPLS) networks), and/or other types of networks such as telecommunication service provider networks.

Network 8 may be implemented using network devices, such as network device 10, that handle (e.g., process by modifying, forwarding, routing, etc.) network traffic to convey information for user applications between end hosts of network 8 and/or generally for other applications or functions between devices (e.g., network devices, hosts, etc.). Network 8 can include networking equipment forming a variety of network devices that interconnect end hosts of network 8. Each instance of network device (e.g., network device 10) in network 8 may be a wireless access point, a network switch (e.g., a multi-layer (Layer2 and Layer 3) switch, a single-layer (Layer 2) switch, etc.), a bridge, a router, a gateway, a hub, a repeater, a firewall, a device serving other networking functions, management equipment that manages and controls the operation of network device(s), or a device that includes the functionality of two or more of these devices.

Each instance of an end host in network 8 can include a computer, a server, a portable electronic device such as a cellular telephone or laptop, another type of specialized or general-purpose host computing equipment (e.g., running one or more client-side and/or server-side applications), a network-connected appliance or device, a device used by network administrators (sometimes referred to as an administrator device), a network service or analysis device, or management equipment that manages and controls the operation(s) of one or more of other end hosts and/or network devices.

In the example of FIG. 1, network 8 includes an illustrative network device 10. While the configuration of and/or operations in connection with a network device are sometimes described herein using network device 10 as an example, this is merely illustrative. If desired, there may be any suitable number of (other) network devices in network 8 that are configured and/or operate in a manner analogous to the manner described herein for device 10.

In some illustrative network configurations sometimes described herein as an example, network device 10 may be a network switch. In other network configurations, device 10 may be another type of network device. Network device 10 may be communicatively coupled to a device 12 via one or more intervening devices or may be communicatively coupled to device 12 directly (e.g., via a direct cable connection, without any intervening network devices, etc.). Device 12 may be another network device of network 8 (e.g., a wireless access point, a network switch, etc.) or may be an end host of network 8, as examples. When device 12 is implemented as a wireless access point, device 12 may further provide a wireless network through which end hosts of network 8 are communicatively coupled to network device 10 and a portion of network 8 (e.g., network portion 8A).

To ensure that network devices and/or hosts are authorized to connect to network 8, authentication equipment (e.g., implemented as an end host of network 8) may be communicatively coupled to some network devices of network 8. In some illustrative configurations described herein as an example, authentication equipment may be implemented on server equipment, e.g., as a client authentication and/or network device authentication server 14. The server equipment on which authentication server 14 is implemented may include server hardware such as one or more blade servers, one or more rack servers, and/or one or more tower servers. Server 14 may include processing circuitry 16 and memory circuitry 18 that collectively implement the functions of authentication server 14 and are provided as part of the server hardware.

Processing circuitry 16 (e.g., compute device(s) of authentication server 14) may include one or more processors such as central processing units (CPUs), graphics processing units (GPUs), microprocessors, general-purpose processors, host processors, microcontrollers, digital signal processors, programmable logic devices (e.g., field programmable gate array (FPGA) devices), application specific system processors (ASSPs), application specific integrated circuit (ASIC) processors, and/or other types of processors.

Memory circuitry 18 (e.g., storage device(s) of authentication server 14) may include non-volatile memory (e.g., flash memory, electrically-programmable read-only memory, a solid-state drive, hard disk drive storage, etc.), volatile memory (e.g., static or dynamic random-access memory), removable storage devices (e.g., storage devices removably coupled to server equipment), and/or other types of memory circuitry.

In general, memory circuitry 18 may include one or more non-transitory (tangible) computer-readable storage media that store the operating system software and/or any other software code, sometimes referred to as program instructions, software, data, instructions, or code. Processing circuitry 16 may run (e.g., execute) an operating system and/or other software (including firmware) stored on the one or more non-transitory computer-readable storage media to perform the operations of authentication server 14 described herein. In other illustrative arrangements, authentication equipment for network 8 (e.g., coupled to network device 10 and other network devices) may be implemented on one or more dedicated local authentication devices or generally implemented using non-server hardware, in place of or in addition to providing authentication server 14.

Authentication server 14 may provide, based on processing circuitry 16 executing instructions stored on memory circuitry 18, one or more authentication services for authorizing network access by different entities (e.g., a user identity authentication service, a client device authentication service, a network device or wireless access point authentication service, etc.). When authorizing network access, authentication server 14 may exchange messages with network device 10 that serves as an authenticator, e.g., to authenticate supplicant device 12 for network access. These messages may be exchanged via any suitable communication path(s). As an example, communication path(s) between network device 10 and server 14 may include (wired) network paths through a wired network (e.g., through network portion 8A and the network devices therein, through the Internet, etc.). If desired, network device 10may be directly connected to server 14 without other intervening network devices.

If desired, authentication server 14 may be or form part of an Authentication, Authorization, and/or Accounting (AAA) server or a network access control server. In some illustrative configurations described herein as an example, authentication server 14 may be a Remote Authentication Dial-In User Service (RADIUS) server that uses the RADIUS protocol to perform AAA operations (e.g., when communicating with network devices of network 8 such as network device 10).

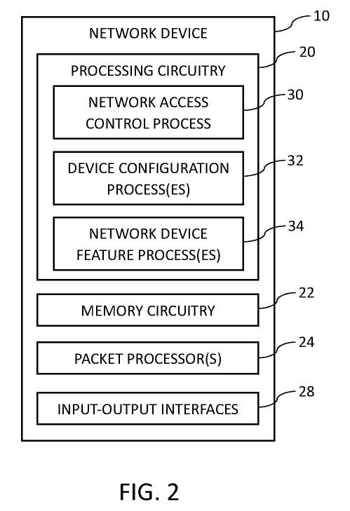

FIG. 2 is a diagram of an illustrative network device (e.g., different instances of which, or variations thereof, can be used to implement different network devices in network 8, such as network device 10). As shown in FIG. 2, network device 10 may include processing circuitry 20, memory circuitry 22, packet processor(s) 24, and/or other components such as input-output interfaces 28 (e.g., network interfaces coupled to other devices in network 8). In one illustrative arrangement, network device 10 may be or form part of a modular network device system (e.g., a modular switch system having removably coupled modules usable to flexibly expand characteristics and capabilities of the modular switch system such as to increase ports, provide specialized functionalities, etc.). In another illustrative arrangement, network device 10 may be a fixed-configuration network device (e.g., a fixed-configuration switch having a fixed number of ports and/or a fixed hardware configuration).

Processing circuitry 20 of network device 10 may include one or more processors such as central processing units (CPUs), graphics processing units (GPUs), microprocessors, general-purpose processors, host processors, microcontrollers, digital signal processors, programmable logic devices (e.g., field programmable gate array (FPGA) devices), application specific system processors (ASSPs), application specific integrated circuit (ASIC) processors, and/or other types of processors. Processing circuitry 20 may run (e.g., execute) a network device operating system and/or other software (including firmware) that is stored on memory circuitry 22. Memory circuitry 22 communicatively coupled to processing circuitry 20 may include one or more non-transitory (tangible) computer-readable storage media that store the operating system software and/or any other software code, sometimes referred to as program instructions, software, data, instructions, or code. In particular, memory circuitry 22 may include non-volatile memory (e.g., flash memory, electrically-programmable read-only memory, a solid-state drive, hard disk drive storage, etc.), volatile memory (e.g., static or dynamic random-access memory), removable storage devices (e.g., storage devices removably coupled to network device 10), and/or other types of memory circuitry.

Processing circuitry 20 and memory circuitry 22 (or at least parts of both) may sometimes be referred to collectively as control circuitry that implements a control plane for network device 10. As just a few examples, processing circuitry 20 may execute network device control plane software such as operating system software, routing policy management software, routing protocol agents or processes, routing information base agents, and other control software, may be used to support the operation of protocol clients and/or servers (e.g., to form some or all of a communications protocol stack), may be used to support the operation of packet processor(s) 24, may store packet forwarding information, may execute packet processing software, and/or may execute other software instructions that control the functions of network device 10 and the other components therein.

Packet processor(s) 24 may be used to implement a data plane or forwarding plane of network device 10. Packet processor(s) 24 may include one or more processors such as programmable logic devices (e.g., field programmable gate array (FPGA) devices), application specific system processors (ASSPs), application specific integrated circuit (ASIC) processors, central processing units (CPUs), graphics processing units (GPUs), microprocessors, general-purpose processors, host processors, microcontrollers, digital signal processors, and/or other types of processors.

A packet processor 24 may receive incoming (ingress) network traffic via input-output interfaces 28, parse and analyze the received network traffic, process the network traffic based on packet forwarding decision data (e.g., in a forwarding information base) and/or in accordance with network protocol(s) or other forwarding policy, and forward (or drop) the network traffic accordingly (e.g., egress the processed network traffic via input-output interfaces 28). The packet forwarding decision data may be stored on memory circuitry integrated as part of and/or separate from packet processor 24 (e.g., on content-addressable memory), and/or on a portion of memory circuitry 22. Memory circuitry for packet processor 24 may include volatile memory, non-volatile memory, and/or other types of memory circuitry.

Input-output interfaces 28 of network device 10 may include one or more different types of communication interfaces such as Ethernet interfaces, optical interfaces, and/or other types of communication interfaces for connecting network device 10 to the Internet, local area network(s), wide area network(s), and/or generally other network device(s) (e.g., device 12 in FIG. 1), peripheral devices, and computing equipment (e.g., host equipment such as server equipment for server 14, end hosts of network 8 such as device 12 in FIG. 1, etc.). Accordingly, at least some of interfaces 28 may be network interfaces (e.g., implemented on exterior-facing ports of device 10) usable to connect to external equipment (e.g., network devices, host equipment, etc.) that form a part of network 8.

In illustrative configurations sometimes described herein as an example, input-output interfaces 28 include Ethernet interfaces, e.g., forming network interfaces, implemented using and therefore include Ethernet ports (e.g., exterior-facing ports). In particular, physical layer and/or data link layer interface circuitry in network device 10 may be coupled to the ports and use the ports to form Ethernet interfaces. This example is merely illustrative. Other types of wired interfaces 28 may be implemented on other types of ports. In general, these ports may be physically coupled and electrically connected to corresponding mating connectors of external equipment, when received at the ports, and may have different form-factors to accommodate different cables, different modules, different devices, or generally different external equipment. If desired, some of input-output interfaces 28 may include wireless interfaces (e.g., WLAN interfaces, etc.) formed using wireless communication circuitry of network device 10 for wirelessly connecting to external equipment (e.g., end hosts of network 8).

Network device 10 may include other components such as power supply components, power management components, interconnect structures such as a communication bus that communicatively couple the internal components of device 10 to one another, to power supply and/or management components, to the control circuitry, etc. The control circuitry (e.g., processing circuitry 20 and/or memory circuitry 22) of device 10 may be communicatively coupled to other components of device 10 via one or more paths (in the communication bus or elsewhere) that enable the reception and transmission of control signals, data, and/or other information therebetween.

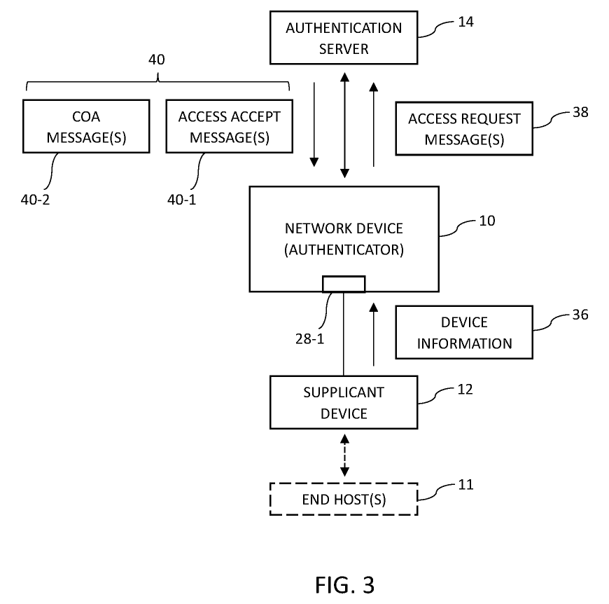

In some illustrative examples described herein, network device 10 may be used to implement an authenticator for other devices, such as supplicant device 12 in FIG. 1. Accordingly, processing circuitry 20 of network device 10 may execute network access control process 30 (sometimes referred to as network access control agent 30) that facilitates the authentication of devices (e.g., network devices and/or end hosts) for network access in accordance with a network access control protocol. Some illustrative operations performed by processing circuitry 20, when executing process 30, are further described in connection with FIGS. 3-9.

In some illustrative examples described herein, network device 10 may be configured to obtain, maintain, apply, manage, and/or otherwise handle network device configuration information (e.g., device configuration(s) that control the manner in which device 10 and its components operate, include device interface configuration(s)). Accordingly, processing circuitry 20 of network device 10 may execute one or more device configuration processes 32 (sometimes referred to as device configuration agents 32) that handle the network device configuration information. If desired, different device configuration processes 32 may be used to handle different types of network device configuration information (e.g., static interface configuration(s), dynamic interface configuration(s), etc.) or may be organized in other manners. Some illustrative operations performed by processing circuitry 20, when executing process(es) 32, are further described in connection with FIGS. 3-9.

In some illustrative examples described herein, network device 10 may be configured to provide, manage, and/or otherwise implement different network device (functional) features (e.g., based on the device configuration information handled by process(es) 32). Accordingly, processing circuitry 20 of network device 10 may execute one or more network device feature processes 34 (sometimes referred to as network device feature agents 34) that implement the network device features. If desired, each network device feature process 34 may be used to implement a different network device feature (e.g., a different type of network device functionality). As examples, processes 34 may include a bridging feature process that handles a bridging feature (e.g., the traffic bridging functionality of device 10), a port security feature process that handles a port security feature (e.g., the port traffic control functionality of device 10), a network access control (feature) process (e.g., process 30 may be considered a feature process 34), a feature process that handles access control list (ACL) policy, a feature process that handles traffic mirroring policy features, a feature process that handles traffic policing policy, and/or numerous other types of network device feature processes. Some illustrative operations performed by processing circuitry 20, when executing process(es) 34, are further described in connection with FIGS. 3-9.

Processing circuitry 20 may execute processes 30, 32, and 34 by executing software instructions stored on memory circuitry 22 (e.g., one or more non-transitory computer-readable storage media). While processes 30, 32, 34 are sometimes described herein to perform respective parts of the operations for facilitating the network authentication of devices, for handling the network device configuration information, and for implementing the network device features, this is merely illustrative. Processing circuitry 20 may be organized and configured in any suitable manner (e.g., to execute any other processes or agents instead of or in addition to processes 30, 32, and 34) to perform each part of these operations. Accordingly, processing circuitry 20 may sometimes be described herein to perform these operations instead of specifically referring to the one or more agents, processes, and/or kernel executed by and implemented on processing circuitry 20.

FIG. 3 is a diagram of an illustrative authenticator network device configured to perform (or otherwise facilitate) an authentication operation for providing network access to a supplicant device using an authentication entity, such as an authentication server. Configurations in which a protocol in compliance with or otherwise compatible with IEEE 802.1X is used to perform the authentication operation described in connection with FIG. 3 are sometimes described herein as an example. The one or more protocols that are in compliance with or otherwise compatible with IEEE 802.1X, or if desired, other standardized or proprietary protocols for achieving network access control may each generally be referred to herein as a network access control protocol. Any suitable network access control protocol may be used in connection with the embodiments described herein.

In the example of FIG. 3, network device 10 may serve as the authenticator for performing the authentication operation for device 12, device 12 may serve as the supplicant, and authentication server 14 (e.g., a RADIUS server) may serve as the authentication server for authenticating network access by supplicant device 12. In scenarios in which supplicant device 12 is a network device, device 12, when authenticated, may further be coupled to and convey network traffic for one or more end hosts 11 of network 8.

When supplicant device 12 is communicatively coupled to interface 28-1 of network device 10 (e.g., an instance of input-output interface 28 in FIG. 2), supplicant device 12 may provide network device 10 with supplicant device information 36, such as an identifier (e.g., a hardware or Media Access Control (MAC) address) of device 12, a certificate, key, or other cryptographic information for validating the authenticity of device 12, its manufacturer, or its user, and/or other types of information that may help facilitate authentication of supplicant device 12 for connecting to (at least a portion of) network 8 and establishing trust for operation as part of network 8.

In particular, supplicant device 12 may generate a message containing information 36 (e.g., a message requesting authentication of device 12 for network access) and may transmit, using an input-output interface (e.g. a network interface) on supplicant device 12, the message containing device information 36 to network device 10. Network device 10 (e.g., processing circuitry 20 thereof) may receive the message containing information 36 via interface 28-1, communicatively coupled to the input-output interface of supplicant device 12 via a wired connection with or without intervening network device(s). Network interface 28-1 may generally be configured to convey network traffic for (e.g., to and/or from) supplicant device 12.

Based on receiving the message at interface 28-1 and in response to processing the message containing information 36, processing circuitry 20 of network device 10 may provide (e.g., generate) a network access request for supplicant device 12, e.g., in access request message 38. Access request message 38 may include at least some (e.g., all) of device information 36 to facilitate the authentication of supplicant device 12. Processing circuitry 20 of network device 10 may transmit access request message 38 (e.g., using another input-output interface 28 of device 10 different from interface 28-1, through a network path in network 8, etc.) to authentication server 14 which provides a supplicant device authentication service (e.g., implemented by processing circuitry 16 executing corresponding instructions stored on memory circuitry 18 in FIG. 1).

Responsive to receiving access request message 38, authentication server 14 (e.g., processing circuitry 16 thereof) may process request message 38 and any device information 36 therein to determine whether or not to authenticate supplicant device 12 for network access. As one illustrative example, processing circuitry 16 of server 14 may perform one or more lookup operations and/or cryptographic operations, using device information 36 in request message 38 as the input or key, to determine (based on the output of these operations) whether or not device 12 should be authenticated.

After authenticating supplicant device 12, server 14 (e.g., processing circuitry 16 thereof) may provide (e.g., generate) a network access response for supplicant device 12, e.g., in an access response message, such as access accept message 40-1 indicative of successful authentication of device 12 for network access (e.g., to at least a portion of network 8). Server 14 (e.g., processing circuitry 16 thereof) may transmit, using a network interface of server 14, access accept message 40-1 to network device 10 (e.g., through a network path in network 8). Upon receiving message 40-1, network device 10 may authorize or grant network access to device 12 by conveying network traffic between device 12 and at least a portion of network 8, thereby indicating successful authentication to device 12. If desired, supplicant device 12 may receive, from network device 10, a separate message indicative of its successful authentication, following the reception of message 40-1 by network device 10.

In some instances, prior to providing and transmitting an access accept message 40-1, authentication server 14 may transmit other types of messages such as an access challenge message to request further information regarding supplicant device 12 from network device 10. Upon network device 10 obtaining the additional requested information from supplicant device 12 and conveying the requested information to authentication server 14, authentication server 14 may subsequently generate and transmit access accept message 40-1 to device 10 based on the additional information.

In a similar manner, network device 10 may authenticate any suitable number of supplicant devices 12 of different types (e.g., for network access on corresponding network interfaces 28). Similarly, other authenticator network devices in network 8 may also authenticate corresponding supplicant devices 12 (e.g., for network access on their corresponding network interfaces, using server 14, etc.).

Network interfaces, such as interface 28-1, should each be configured to implement one or more network device features in a desired manner (e.g., configuring the interface as a trunk or access port, specifying membership of the interface in one or more virtual local area networks (VLANs), enabling or disabling port security policy thereon, enabling or disabling port-based authentication thereon, etc.) for the corresponding device coupled to that interface. However, there are scenarios in which multiple different types of external devices (e.g., associated with different vendors, having different functionalities, and/or generally desiring different interface configurations) can potentially be communicatively coupled to a given network interface. Accordingly, it may be desirable to apply different interface configurations to authenticator network device interfaces depending on the (type of) device connected to that interface. Configuration of a network interface can be performed manually using static configurations (e.g., user input is supplied to specify the desired static configuration(s) in a configuration file or in multiple configuration inputs). However, manual configuration of multiple such interfaces, with a variety of different sets of interface configurations and whenever the connecting device changes to a device of a different type, can be tedious and error-prone. This approach may also be impractical given the difficulty in managing these different interface configurations over time and at scale (e.g., for a large number of network devices, for a wide variety of interface configurations, etc.), especially for dynamic network deployments.

To mitigate these issues (e.g., to avoid having to rely (solely) on manual static configuration of interfaces), at least part of the network interface configuration operation may be performed dynamically, e.g., based on an interface-based authentication operation. For example, authentication equipment such as server 14 in FIGS. 1 and 3 may be configured to provide authenticator devices with information identifying interface configurations (e.g., dynamic interface configurations) for corresponding authenticated or authenticating supplicant devices connected at respective network device interfaces.

In particular, still referring to FIG. 3, authentication server 14 may provide the interface configuration information (sometimes referred to as interface profile information) in one or more types of messages 40 transmitted to network device 10 having interface 28-1 on which supplicant device 12 is authenticated or to be authenticated. As illustrative examples, the interface configuration information (e.g., information containing or otherwise identifying interface configurations) may be included in access accept message(s) 40-1 and/or in change of authorization (COA) messages 40-2. In particular, access accept message(s) 40-1 may be used to carry interface configuration information for newly authenticating (or re-authenticating) supplicant devices to establish (or re-establish) authenticated network access sessions by the supplicant devices. As described above, message(s) 40-1 may be generated and transmitted in response to corresponding access request message(s) 38. Change of authorization message(s) 40-2 may be used to carry interface configuration information for authenticated supplicant devices with active authenticated network access sessions (e.g., to update an interface from existing applied interface configuration(s) to new interface configuration(s) identified by interface configuration information in a message 40-2).

If desired, other types of messages 40 conveyed from authentication server 14 to authenticator device 10 may include the interface configuration information. If desired, authenticator device 10 may obtain the interface configuration information (e.g., identifying dynamic interface configuration(s)) from other external sources. If desired, authenticator device 10 may obtain the interface configuration information locally (e.g., may locally determine dynamic configurations to be applied to certain interfaces 28, for certain types of interface-connected devices, and/or for use when externals sources for interface configuration information are communicatively decoupled from device 10 or are generally unavailable, such as when authentication server 14 is unreachable).

While in some illustrative configurations sometimes described herein as an example, interface configuration information for a supplicant device is applied by network device 10 to an interface when the supplicant device is communicatively coupled to the interface, this is merely illustrative. If desired, the same interface configuration information may be applied to a different interface of network device 10 after the supplicant device has moved to (be communicatively coupled to) the different interface of network device 10.

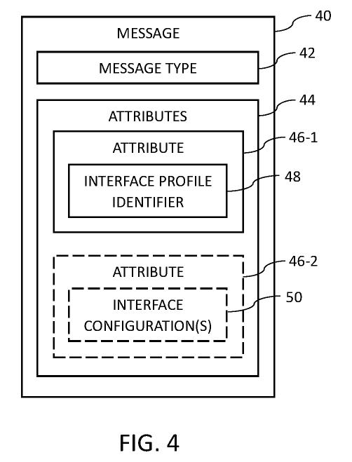

An illustrative message 40 (e.g., an access accept message, a COA message, or another type of message from server 14 to device 10) is shown in FIG. 4. In the example of FIG. 4, a message 40 may include (or otherwise indicate) a message type (e.g., information indicating whether message 40 is an access accept message, a COA message, or another type of message) and certain attributes 44, among other information. Attributes 44 may include a set of standardized and extended attributes (e.g., in compliance with the RADIUS protocol), and vendor-specific attributes. In particular, attributes 44 may include an interface dynamic configuration attribute 46 (e.g., a vendor-specific attribute), referring to either attribute 46-1 or attribute 46-2. An interface dynamic configuration attribute 46 (e.g., either attribute 46-1 or 46-2) eventually identifies the dynamic interface configuration to be applied to the interface.

As a first example, message 40 may include an attribute 46-1 containing an interface profile identifier 48 that identifies an interface profile, which is pre-configured on device 10 and contains a list of interface commands. In this example, attribute 46-1 may sometimes be referred to as an interface profile attribute 46-1. Interface profile attribute 46-1 may include a string (value) that is interpreted (e.g., by processing circuitry 20 of network device 10) as the interface profile identifier (e.g., a name). The dynamic interface configuration 50 can be obtained by retrieving the content of the pre-configured interface profile on device 10.

As a second example (which may be mutually exclusive with the first example), message 40 may include an attribute 46-2 containing the actual interface configuration(s) 50 (e.g., commands or instructions to apply corresponding configurations to an interface). In this example, attribute 46-2 may sometimes be referred to as an interface command attribute 46-2. Interface command attribute 46-2 may include a string (value) that is interpreted (e.g., by processing circuitry 20 of network device 10) as the actual interface configuration 50 (e.g., interface command(s)). Given the limited size (e.g., length) of a single attribute 46-2, multiple attributes 46-2 may be present and combined to obtain the interface configurations 50.

The use of attribute 46-1 or 46-2 in message 40 as described in connection with these examples is merely illustrative. If desired, server 14 may convey interface profile information (e.g., interface profile identifier 48 or interface configuration(s) 50) in other manners to network device 10.

In the first example, message 40 may include an interface profile identifier 48 (in attribute 46-1), without including the specific interface configuration(s) 50 (e.g., may lack interface configuration(s) 50). In this example, network device 10 may use identifier 48 in the received message 40 to obtain the corresponding interface configuration(s) 50, which may be locally stored on device 10.

In particular, network device 10 (e.g., memory circuitry 22 thereof) may maintain (e.g., store) the corresponding set of interface configuration(s) 50 for each identifier 48 (e.g., each identifier 48 relevant to network interfaces 28 of device 10). In such a manner, even when the specific set of interface configuration(s) 50 are absent from a received message 40, network device 10 may obtain the appropriate set of interface configuration(s) 50 for the interface profile identified by message 40 because the appropriate set of interface configuration(s) 50 can be readily accessed locally on device 10.

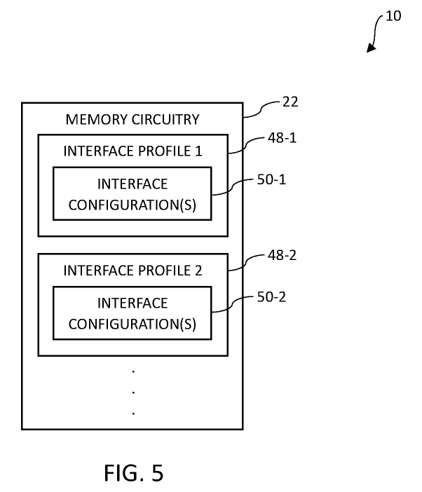

FIG. 5 is a diagram of illustrative memory circuitry 22 of authenticator network device 10 configured to maintain (e.g., store) interface configurations 50 for each interface profile identified by the corresponding identifier 48. As shown in FIG. 5, memory circuitry 22 may store a first set of interface configuration(s) 50-1 for the interface profile identified by identifier 48-1, a second set of interface configuration(s) 50-2 for the interface profile identified by identifier 48-2, etc. In general, memory circuitry 22 may store any suitable number of sets of interface configurations 50 for corresponding interface profile identifiers 48. Accordingly, when processing circuitry 20 of device 10 receives a received message 40 that includes an interface profile identifier 48 (without the corresponding set of interface configuration(s) 50), authenticator device 10 (e.g., processing circuitry 20 thereof) may perform a lookup operation in the maintained sets of interface configuration(s) 50 to identify which of the stored interface profile identifiers 48 matches the received identifier 48 and may obtain the stored set of interface configuration(s) 50 for the identified identifier 48.

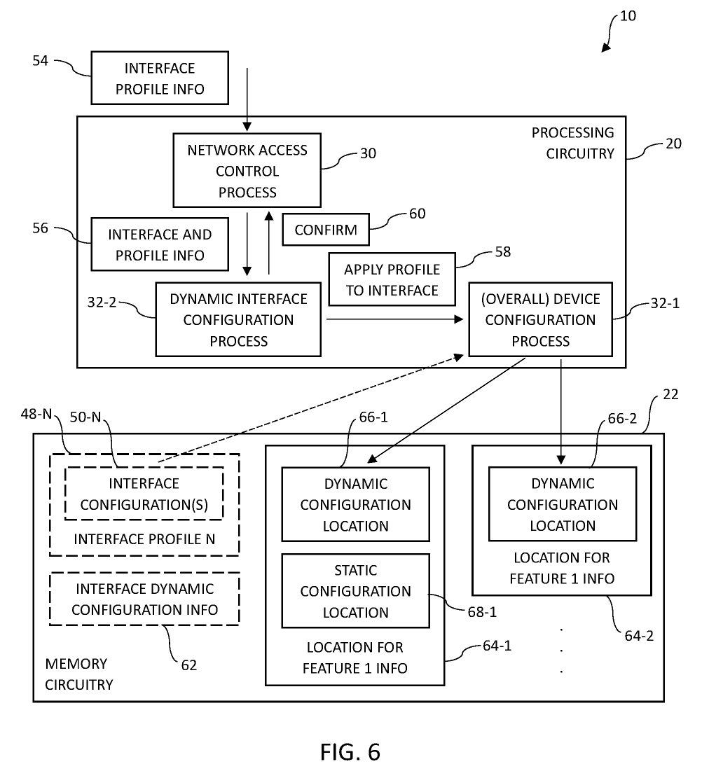

Based on receiving message 40, network device 10 may apply interface configuration(s) 50 (indicated by the corresponding identifier 48 in attribute 46-1 of message 40 as in the first example, or directly included in attribute 46-2 message 40 as in the second example) to the appropriate interface coupled to the supplicant device. FIG. 6 is a diagram of illustrative network device processing circuitry 20 configured to obtain interface profile information 54 (e.g., referring to an interface profile identifier 48 or the corresponding set of interface configuration(s) 50, whichever is in received message 40) and apply the corresponding interface profile identified in information 54 to interface 28-1 of supplicant device 12-1 (FIG. 3). In particular, processing circuitry 20 may apply interface profile to interface 28-1 by implementing corresponding network device features with the interface configurations 50 applied to interface 28-1.

In the example of FIG. 6, processing circuitry 20, when executing network access control process 30, may perform an authentication operation for supplicant device 12 using server 14 and may therefore receive interface profile information 54 as part of the authentication process (e.g., in an access accept message 40-1 in FIG. 3). In other instances, processing circuitry 20, when executing network access control process 30, may receive interface profile information 54 in an update message (e.g., change of authorization message 40-2 in FIG. 3) for the ongoing authenticated network access session of supplicant device 12. If desired, processing circuitry 20, when executing network access control process 30, may receive interface profile information 54 in other manners, such as via interface profile configuration derived based on local network device configuration and/or input(s) from other network entities. Network access control process 30 (e.g., executed by processing circuity 20) may convey, to dynamic interface configuration process 32-2 (e.g., executed by processing circuity 20), information 56 containing or otherwise identifying the received interface profile information 54 and the corresponding network interface 28-1 to which information 54 should be applied. The conveyance of this information 56 by network access control process 30 may include storing information 56 as interface dynamic configuration information 62, at a location in a database (e.g., stored on memory circuitry 22). Dynamic interface configuration process 32-2 may subsequently access information 62 stored by network access control process 30.

Dynamic interface configuration process 32-2 may convey instruction(s) 58 to (overall) device configuration process 32-1 (e.g., executed by processing circuitry 20). Instruction(s) 58 may instruct process 32-1 to apply the interface profile (e.g., identified in information 56) to interface 28-1 (identified in information 56) as dynamic configuration(s). In addition to receiving input configurations from process 32-2, device configuration process 32-1 may also provide other interfaces (e.g., application programming interfaces, a command line interface, etc.) through which input configurations (e.g., static and/or dynamic configurations) can be received and applied. In some illustrative configurations described herein as an example, interface configurations 50 (e.g., configurations 50-N to be applied to interface 28-1 in FIG. 3) may be in the form of command line interface (CLI) commands, application programming interface (API) commands, or other types of commands that can be handled by device configuration process 32-1 as inputs. If desired, interface configurations 50 may be in other forms.

After receiving instruction(s) 58 to apply the interface profile to interface 28-1, device configuration process 32-1 may obtain, if not already obtained (e.g., if not already included in information 56), the actual set of interface configuration(s) 50-N corresponding to the interface profile identifier in information 56 (e.g., identifier 48-N). Interface configurations(s) 50-N may be obtained out of multiple sets of interface configuration(s) 50 (e.g., configuration(s) 50-1, 50-2, etc.) maintained on memory circuitry 22 as described in connection with FIG. 5. Device configuration process 32-1 may then store the set of interface configuration(s) 50-N as applied to interface 28-1 at various locations 66 for dynamic configuration information on memory circuitry 22.

In particular, interface configurations 50-N as applied to interface 28-1 may be applicable to different network device feature processes 34 (e.g., a bridging feature process, a port security feature process, a network access control feature process, etc.) and may each be stored at a dynamic configuration storage location 66 on memory circuitry 22 accessible to the applicable network device feature process 34. For example, as shown in FIG. 6, processing circuitry 20 (e.g., when executing process 32-1) may store one or more dynamic configurations 50-N applicable to a first feature (e.g., handled by a first feature process, such as a bridging feature process 34) at storage location 66-1, may store one or more dynamic configurations 50-N applicable to a second feature (e.g., handled by a second feature process, such as a port security feature process 34) at storage location 66-2, etc. In general, information for use by a network device feature process 34 may be maintained at location 64, which can include a dynamic configuration storage location 66 and/or a static configuration storage location 68.

By storing the set of dynamic configuration(s) 50-N as applied to interface 28-1 appropriately across different dynamic configuration storage locations 66 for all applicable network device features, processing circuitry 20 may have effectively applied the dynamic configurations 50-N (e.g., the interface profile identified by or contained in information 54 from server 14) to interface 28-1.

Still referring to FIG. 6, if desired, at a suitable time (e.g., after instructing device configuration process 32-1 to apply the profile identified by identifier 48-N to the corresponding interface), dynamic interface configuration process 32-2 may convey a confirmation message 60 back to network access control process 30 confirming that the interface profile has been applied to the interface as dynamic configurations. If desired, another interface profile may be applied thereafter on an interface on which a first interface profile has already been applied.

While the example of FIG. 6 shows how processing circuitry 20 may receive information 54 from an external source (e.g., server 14), this is merely illustrative. If desired, in some scenarios (e.g., when server 14 is communicatively decoupled from device 10, when device 10 is configured with a set of default dynamic configuration(s), etc.), network device processing circuitry 20 may locally determine or generate information 54 (e.g., based on which of the corresponding dynamic configuration(s) 50-N may be applied to interface 28-1).

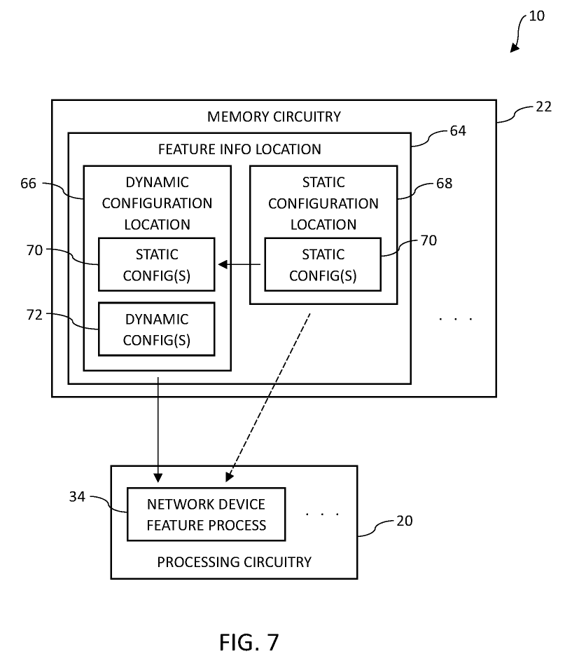

Once the appropriate information has been stored at locations 64 (e.g., dynamic configurations have been stored at locations 66), network device features may utilize the dynamic configurations along with (non-conflicting) static configurations. In particular, as shown in the example of FIG. 7, dynamic configuration storage location 66 in each feature information storage location 64 may store both static configuration(s) 70 for interface 28-1 (FIG. 3) and dynamic configuration(s) 72 for interface 28-1 (e.g., a subset of configurations 50-N in FIG. 7 applicable to the feature associated with location 64).

In illustrative configurations sometimes described herein as an example, static configuration(s) 70 may initially be stored and maintained at static configuration location 68 (and not at dynamic location 66). These static configuration(s) 70 at location 68 may be pre-configured (e.g., prior to a supplicant device 12 being coupled to interface 28-1) by configuration process 32-1 (e.g., based on configuration input received using a command line interface, an application programming interface, etc.).

Processing circuitry 20 (e.g., when executing device configuration process 32-1) may, for each feature process 34, store a copy of static configuration(s) 70, initially at static configuration location 68, additionally at dynamic configuration location 66. Processing circuitry 20 (e.g., when executing device configuration process 32-1) may further store interface dynamic configuration(s) 72 at the dynamic configuration location 66, along with static configuration(s) 70 copied from location 68.

In some scenarios, some of the static configuration(s) 70 originally stored at location 68 may conflict with corresponding dynamic configuration(s) 72. In these scenarios, the conflicting static configuration(s) may be removed from the copy stored at location 66, or the conflicting portion of the copy may be replaced by one or more replacement configurations 72, such that configurations at location 66 are conflict-free.

While interface configurations are present at both locations 66 and 68, processing circuitry 20 (e.g., when executing the corresponding network device feature process 34) may be configured to prioritize the use of configurations at dynamic configuration location 66 (e.g., configurations 70 and 72) over the use of configurations at static configuration location 68 (e.g., configurations 70). Accordingly, dynamic interface configurations obtained as part of the authentication process or generally for an authenticated or authenticating supplicant device may be preferentially applied over any (conflicting) existing static configurations and along with (non-conflicting) existing static configurations for the interface.

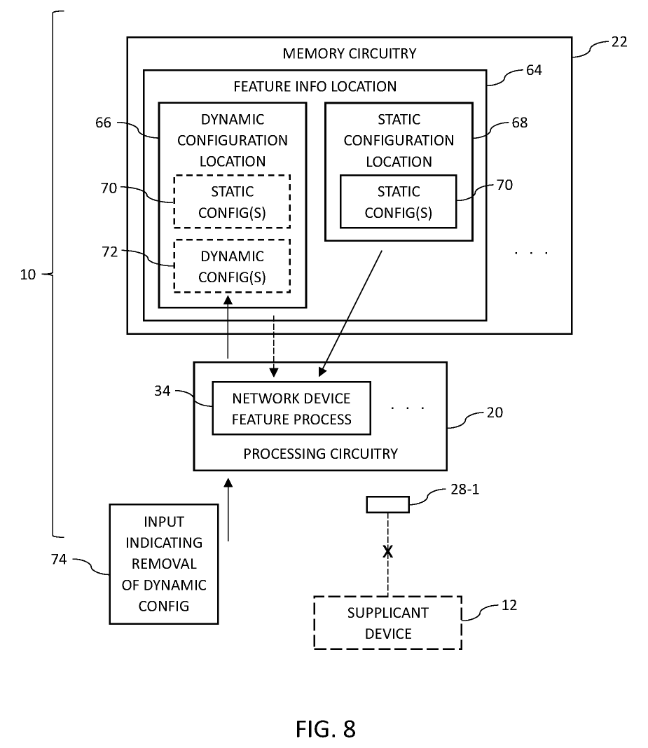

In some scenarios, dynamic interface configurations for an interface (e.g., interface 28-1) may be removed and the interface may revert back to a state in which static configurations (without dynamic configurations) are applied to the interface. FIG. 8 is a diagram of illustrative network device processing circuitry 20 configured to handle removal of dynamic configurations. As shown in FIG. 8, network device processing circuitry 22 may receive input 74 indicative of dynamic configuration removal.

As examples, input 74 may include an indication of supplicant device 12 being disconnected from (e.g., using Extensible Authentication Protocol over LAN (EAPOL) logoff), idle on, or generally communicatively decoupled from the (originally) connected interface 28-1 (and no other supplicant devices remain connected on the same interface 28-1), may include a disconnect message from server 14 indicating that supplicant device 12 be disconnected from interface 28-1, may include an interface configuration update message (e.g., COA message 40-2) from server 14 indicating that no dynamic configurations should be applied to interface 28-1, may include user (e.g., admin) input specifying disconnection of supplicant device 12 and/or removal of applied dynamic configurations, and/or other indications for removing dynamic configurations.

Responsive to input 74, network device processing circuitry 20 (e.g., device configuration process 32-1 executing thereon) may remove all configurations (e.g., copied static configuration(s) 70 and dynamic configuration(s) 72) from each dynamic configuration location 66 (e.g., as applied to interface 28-1) across all device feature information locations 64. Thereafter, processing circuitry 20 (e.g., when executing each corresponding network device feature process 34) may be configured to revert back to and apply static configuration(s) 70 at the corresponding static configuration location 68 to interface 28-1 (e.g., based on the lack of configurations at dynamic configuration location 66).

The operations in connection with using configurations for a feature from dynamic configuration location 66 as described in connection with FIG. 7 or from static configuration location 68 as described in connection with FIG. 8 may be performed on a per-interface basis. For example, a first interface 28 (FIG. 2) may have dynamic configurations populated (as described in connection with FIG. 7) and feature 34 may perform the operations in connection with FIG. 7 for the first interface 28, while a second interface 28 (FIG. 2) may not have dynamic configurations populated (as described in connection with FIG. 8) and the same feature 34 may perform the operations in connection with FIG. 8 for the second interface 28.

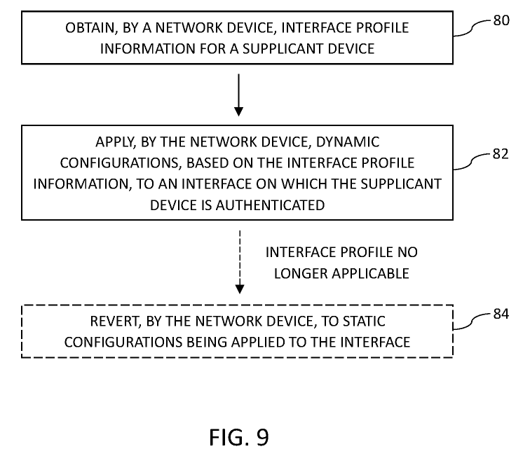

FIG. 9 is a flowchart of illustrative operations for receiving and applying interface profile information (e.g., dynamic configurations) obtained in connection with network access control (e.g., a network access authentication operation). In particular, these operations may be performed by processing circuitry of a network device, such as processing circuitry 20 of network device 10, using other components of the network device (e.g., memory circuitry 22, processing circuitry 24, and/or interfaces 28 of device 10). In configurations sometimes described herein as an illustrative example, the operations described in connection with FIG. 9 may be performed by the network device processing circuitry (e.g., processing circuitry 20) executing software instructions stored on corresponding network device memory circuitry (e.g., memory circuitry 22). If desired, one or more operations described in connection with FIG. 9 may be performed by other (dedicated) hardware components in the network device. If desired, processing circuitry and memory circuitry of other types of devices may similarly be configured to perform the operations described in connection with FIG. 9.

At block 80, one or more processors (e.g., processing circuitry 20 of network device 10) may obtain interface profile information for an authenticated or authenticating supplicant device. In illustrative configurations described herein as an example, the interface profile information may be obtained (e.g., received) from external equipment such an authentication server in connection with a network access authentication operation for the supplicant device. The interface profile information may include an identifier of a particular interface profile to be applied to the interface on which the supplicant device is authenticated or authenticating for network access and/or may include the actual interface configurations of the interface profile. If desired, the operations at block 80 may include one or more of the operations (e.g., performed by device 10) described in connection with FIGS. 3-5.

At block 82, the one or more processors may apply dynamic configurations, based on the obtained interface profile information, to the interface on which the supplicant device is authenticated or authenticating. Different dynamic configurations may be applicable to different network device features. Accordingly, to apply the dynamic configurations, the one or more processors may store each set of one or more dynamic configuration(s) relevant to a corresponding feature at a corresponding (memory) location for the feature process implementing that feature. In illustrative configurations described herein as an example, the dynamic configurations may be applied in addition to non-conflicting static configurations (e.g., already configured for the interface prior to obtaining the interface profile information at block 80). Accordingly, the one or more processors may store the dynamic configuration(s) along with (non-conflicting) static configuration(s) at corresponding locations for respective feature processes, thereby applying the dynamic configurations. Each feature process may access corresponding dynamic configuration(s) and (non-conflicting) static configuration(s) to implement its functionality in the desired manner (e.g., based on the interface profile). If desired, the operations at block 82 may include one or more of the operations (e.g., performed by device 10) described in connection with FIGS. 6 and 7.

If and when the interface profile (e.g., the dynamic configurations) is no longer applicable (e.g., based on the supplicant device being communicatively decoupled, based on the dynamic configurations being disabled by user input or by the authentication server, etc.), at block 84, the one or more processors may revert back to static configurations (without dynamic configurations) being applied to the interface on which the supplicant device is (or was previously) authenticated. If desired, the operations at block 84 may include one or more of the operations (e.g., performed by device 10) described in connection with FIG. 8.

The operations described in connection with FIGS. 3-9 may be performed for each applicable supplicant device to apply the appropriate interface configurations to the corresponding authenticator interface (e.g., across one or more authenticator network devices coupled to server 14) as dynamic configurations. In such a manner, these operations may provide a scalable and easily manageable technique to dynamically implement interface configurations for different types of supplicant devices.

The methods and operations described above in connection with FIGS. 1-9 may be performed by the components of network device(s) and/or server(s) or other host equipment using software (including firmware) and/or hardware (e.g., dedicated circuitry or hardware). Software code for performing these operations may be stored on one or more non-transitory computer-readable storage media (e.g., tangible computer-readable storage media) stored on one or more of the components of the network device(s) and/or server(s) or other host equipment. The software code may sometimes be referred to as software, data, instructions, program instructions, or code. The non-transitory computer-readable storage media may include drives, non-volatile memory such as non-volatile random-access memory (NVRAM), removable flash drives or other removable media, other types of random-access memory, etc. Software stored on the non-transitory computer readable-storage media may be executed by processing circuitry of the network device(s) and/or server(s) or other host equipment (e.g., processing circuitry 16 of server 14 in FIG. 1, processing circuitry 20 of network device 10 in FIG. 2, etc.).

The foregoing is merely illustrative and various modifications can be made to the described embodiments. The foregoing embodiments may be implemented individually or in any combination.

What is claimed is:

1. A network device comprising:
a network interface;
memory circuitry; and
processing circuitry coupled to the network interface and the memory circuitry and configured to:
perform an authentication operation for a supplicant device communicatively coupled to the network interface;
obtain a set of one or more dynamic configurations for the network interface based on the supplicant device being authenticated or authenticating on the network interface; and
apply the set of one or more dynamic configurations to the network interface.

2. The network device defined in claim 1, wherein the processing circuitry is configured to receive a message from an authentication server and wherein the message identifies the set of one or more dynamic configurations.

3. The network device defined in claim 2, wherein the message contains an interface profile identifier, wherein the memory circuitry is configured to maintain, on the memory circuitry, different sets of dynamic configurations for corresponding interface profile identifiers, and wherein the processing circuitry is configured to obtain the set of one or more dynamic configurations out of the maintained sets of dynamic configurations based on the interface profile identifier in the message.

4. The network device defined in claim 2, wherein the message contains the set of one or more dynamic configurations and wherein the processing circuitry is configured to obtain the set of one or more dynamic configurations from the message.

5. The network device defined in claim 2, wherein the message is an access accept message or a change of authorization message.

6. The network device defined in claim 5, wherein the message contains an attribute that identifies the set of one or more dynamic configurations.

7. The network device defined in claim 1, wherein the processing circuitry is configured to implement first and second network device features and wherein the set of one or more dynamic configurations comprises a first dynamic configuration for the first network device feature and a second dynamic configuration for the second network device feature.

8. The network device defined in claim 7, wherein the processing circuitry is configured to apply the set of one or more dynamic configurations by storing the first dynamic configuration at a first dynamic configuration storage location for the first network device feature and storing the second dynamic configuration at a second dynamic configuration storage location for the second network device feature.

9. The network device defined in claim 1, wherein the processing circuitry is configured to apply the set of one or more dynamic configurations along with a set of one or more static configurations for the network interface.

10. The network device defined in claim 9, wherein the set of one or more dynamic configurations comprises a given dynamic configuration for a given network device feature, wherein the set of one or more static configurations comprises a given static configuration for the given network device feature, and wherein the processing circuitry is configured to apply the set of one or more dynamic configurations along with the set of one or more static configurations by implementing the given network device feature using the given dynamic configuration and the given static configuration.

11. The network device defined in claim 1, wherein the processing circuitry is configured to:
receive input indicative of dynamic configuration removal for the network interface; and
apply a set of one or more static configurations to the network interface without the set of one or more dynamic configurations based on the received input.

12. The network device defined in claim 11, wherein the received input comprises input indicative of the supplicant device being communicatively decoupled from the network interface.

13. A network device comprising:
a network interface;
memory circuitry; and
processing circuitry coupled to the network interface and the memory circuitry and configured to:
obtain interface configurations for an interface profile as part of an authentication operation for a supplicant device communicatively coupled to the network interface; and
apply the interface configurations to the network interface by:
storing a first interface configuration of the obtained interface configurations at a first dynamic configuration storage location in the memory circuitry for a first network device feature; and
storing a second interface configuration of the obtained interface configurations at a second dynamic configuration storage location in the memory circuitry for a second network device feature.

14. The network device defined in claim 13, wherein the first interface configuration is a dynamic configuration, wherein the processing circuitry is configured to store one or more static configurations at the first dynamic configuration storage location for the first network device feature, and wherein the processing circuitry is configured to apply the dynamic configuration and the one or more static configurations to the network interface to implement the first network device feature.

15. The network device defined in claim 14, wherein the one or more static configurations stored at the first dynamic configuration storage location for the first network device feature are based on one or more corresponding static configurations stored at a static configuration storage location in the memory circuitry for the first network device feature.

16. The network device defined in claim 13, wherein the processing circuitry is configured to:
obtain input indicative of dynamic configuration removal for the network interface; and
apply one or more static configurations to the network interface without the interface configurations by:
removing the first interface configuration from the first dynamic configuration storage location for the first network device feature; and
removing the second interface configuration from the second dynamic configuration storage location for the second network device feature.

17. A network device comprising:
a network interface;
memory circuitry; and
processing circuitry coupled to the network interface and the memory circuitry and configured to:
receive a message from an authentication server, the message containing an interface profile identifier;
obtain a set of one or more dynamic configurations for the network interface based on the interface profile identifier; and
apply the set of one or more dynamic configurations to the network interface.

18. The network device defined in claim 17, wherein the interface profile identifier is in an attribute of the message.

19. The network device defined in claim 18, wherein the message is an access accept message.

20. The network device defined in claim 18, wherein the message is a change of authorization message.
